(19) United States
(12) Patent Application Publication
(10) Pub. No.: US 2025/0096438 A1
(43) Pub. Date: Mar. 20, 2025

(54) CONNECTORS FOR THIN-FILM FUNCTIONAL SEPARATORS IN BATTERY CELLS

(71) Applicant: GM GLOBAL TECHNOLOGY OPERATIONS LLC, DETROIT, MI (US)

(72) Inventors: Anne Zhang, Troy, MI (US); Jing Gao, Rochester, MI (US); Christine Labaza, Rochester, MI (US); Yifan Zhao, Troy, MI (US); Brian J. Koch, Berkley, MI (US); Raneen Taha, Sterling Heights, MI (US)

(21) Appl. No.: 18/469,786

(22) Filed: Sep. 19, 2023

(51) Int. Cl. H01M 50/569; B60L 50/60; H01M 50/449; H01M 50/463; H01M 50/528

(52) U.S. Cl. CPC H01M 50/569; H01M 50/449; H01M 50/463; H01M 50/528; B60L 50/60; H01M 2220/20

(57) ABSTRACT

Some embodiments disclosed herein are directed to connectors for thin-film functional separators in battery cells. In accordance with an exemplary embodiment, a thin-film functional separator for a battery cell is provided. The thin-film functional separator may be disposed within the battery cell, such as between a cathode and anode of the battery cell. The thin-film functional separator includes a porous composite membrane that includes a microporous substrate and a coating layer, and includes a lead extending from the porous composite membrane. The lead extending from the porous composite membrane is coupled to an external conductive tab using a mechanical connector that electrically couples the external conductive tab to the lead extending from the porous composite membrane. Other embodiments may be disclosed or claimed.

### INTRODUCTION

The subject disclosure relates to battery cells. In particular, embodiments of the present disclosure relate to connectors for thin-film functional separators in battery cells.

Batteries are increasingly used in a wide variety of systems, from mobile computing devices to vehicles with electric motors. Such batteries may have multiple cells, each cell including a cathode and an anode which may be separated by a separator. In some cases, the separator may include a thin-film functional separator adapted to perform one or more functions, such as to measure the internal temperature of the battery cell. These thin-film functional separators require an electric coupling to provide current to one or more components of the functional separator.

Among other things, embodiments of the present disclosure are directed to enhanced mechanical connectors that provide a stable, durable electric connection between a thin-film functional separator and an external conductive tab within the corrosive environment inside a battery cell.

### SUMMARY

In one exemplary embodiment, a thin-film functional separator for a battery cell includes a porous composite membrane that includes a microporous substrate and a coating layer, and includes a lead extending from the porous composite membrane. The thin-film functional separator further includes an external conductive tab and a mechanical connector that electrically couples the external conductive tab to the lead extending from the porous composite membrane.

In addition to one or more of the features described herein, the thin-film functional separator is disposed within the battery cell.

In addition to one or more of the features described herein, the mechanical connector includes crimping the external conductive tab together with the lead extending from the porous composite membrane.

In addition to one or more of the features described herein, the mechanical connector includes a strip of conductive material that is wrapped through a first slit in the lead extending from the porous composite membrane and through a second slit in the lead extending from the porous composite membrane, and the strip of conductive material is welded to the external conductive tab.

In addition to one or more of the features described herein, the strip of conductive material is formed from a material in common with the external conductive tab.

In addition to one or more of the features described herein, the mechanical connector includes a strip of conductive material that is wrapped through a slit in the lead extending from the porous composite membrane and through a slit in the strip of conductive material, and wherein the strip of conductive material is welded to the external conductive tab.

In addition to one or more of the features described herein, the strip of conductive material is formed from a material in common with the external conductive tab.

In addition to one or more of the features described herein, the mechanical connector includes a strip of conductive material that is wrapped through a slit in the lead extending from the porous composite membrane and folded around, and welded to, the external conductive tab.

In another exemplary embodiment, a battery cell includes an anode, a cathode, and a thin-film functional separator disposed between the anode and the cathode. The thin-film functional separator includes a porous composite membrane that includes a microporous substrate and a coating layer, and includes a lead extending from the porous composite membrane. The thin-film functional separator further includes an external conductive tab and a mechanical connector that electrically couples the external conductive tab to the lead extending from the porous composite membrane.

In addition to one or more of the features described herein, the mechanical connector includes crimping the external conductive tab together with the lead extending from the porous composite membrane.

In addition to one or more of the features described herein, the mechanical connector includes a strip of conductive material that is wrapped through a first slit in the lead extending from the porous composite membrane, through a second slit in the lead extending from the porous composite membrane, and the strip of conductive material is welded to the external conductive tab.

In addition to one or more of the features described herein, the strip of conductive material is formed from a material in common with the external conductive tab.

In addition to one or more of the features described herein, the mechanical connector includes a strip of conductive material that is wrapped through a slit in the lead extending from the porous composite membrane and through a slit in the strip of conductive material, and wherein the strip of conductive material is welded to the external conductive tab.

In addition to one or more of the features described herein, the strip of conductive material is formed from a material in common with the external conductive tab.

In addition to one or more of the features described herein, the mechanical connector includes a strip of conductive material that is wrapped through a slit in the lead extending from the porous composite membrane and folded around, and welded to, the external conductive tab.

In another exemplary embodiment, a vehicle includes an electric motor and a battery cell coupled to the electric motor. The battery cell includes an anode, a cathode, and a thin-film functional separator disposed between the anode and the cathode. The thin-film functional separator comprises a porous composite membrane that includes a microporous substrate and a coating layer, and includes a lead extending from the porous composite membrane. The thin-film functional separator further includes an external conductive tab and a mechanical connector that electrically couples the external conductive tab to the lead extending from the porous composite membrane.

In addition to one or more of the features described herein, the mechanical connector includes crimping the external conductive tab together with the lead extending from the porous composite membrane.

In addition to one or more of the features described herein, the mechanical connector includes a strip of conductive material that is wrapped through a first slit in the lead extending from the porous composite membrane, through a second slit in the lead extending from the porous composite membrane, wherein the strip of conductive material is welded to the external conductive tab, and wherein the strip of conductive material is formed from a material in common with the external conductive tab.

In addition to one or more of the features described herein, the mechanical connector includes a strip of conductive material that is wrapped through a slit in the lead extending from the porous composite membrane and through a slit in the strip of conductive material, wherein the strip of conductive material is welded to the external conductive tab, and wherein the strip of conductive material is formed from a material in common with the external conductive tab.

In addition to one or more of the features described herein, the mechanical connector includes a strip of conductive material that is wrapped through a slit in the lead extending from the porous composite membrane and folded around, and welded to, the external conductive tab.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a diagram of a vehicle for use in conjunction with one or more embodiments of the present disclosure;

FIG. 2 is a diagram illustrating a battery cell with a thin-film functional separator in accordance with embodiments of the present disclosure

FIG. 3A is a sectional diagram illustrating an embodiment of a mechanical connector for a thin-film functional separator in accordance with embodiments of the present disclosure;

FIG. 3B is another sectional diagram illustrating a through-hole variant of the mechanical connector in FIG. 3A in accordance with embodiments of the present disclosure;

FIG. 4A is a sectional diagram illustrating another embodiment of a mechanical connector for a thin-film functional separator in accordance with embodiments of the present disclosure;

FIG. 4B is a sectional diagram illustrating another embodiment of a mechanical connector for a thin-film functional separator in accordance with embodiments of the present disclosure; and

FIG. 4C is a sectional diagram illustrating another embodiment of a mechanical connector for a thin-film functional separator in accordance with embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a thin-film functional separator for a battery cell is provided. The thin-film functional separator may be disposed within the battery cell, such as between a cathode and anode of the battery cell. The thin-film functional separator includes a porous composite membrane that includes a microporous substrate and a coating layer, and includes a lead extending from the porous composite membrane. The lead extending from the porous composite membrane is coupled to an external conductive tab using a mechanical connector that electrically couples the external conductive tab to the lead extending from the porous composite membrane.

In this manner, embodiments of the present disclosure provide connections between thin-film functional separators, that can provide a variety of functions, to conductive tabs that interface with external circuitry and equipment. Among other things, the connectors of the present disclosure do not interfere with the hermetic seal necessary to keep air out of a battery cell (e.g., in a lithium-based battery), provide sufficient conductivity for the tab-separator interface, do not introduce materials incompatible with the corrosive environment that is inside a battery, provide sufficient mechanical/fatigue strength to endure throughout the lifetime of the battery (despite being attached to the thin substrate of the thin-film functional separator), and can be implemented at scale.

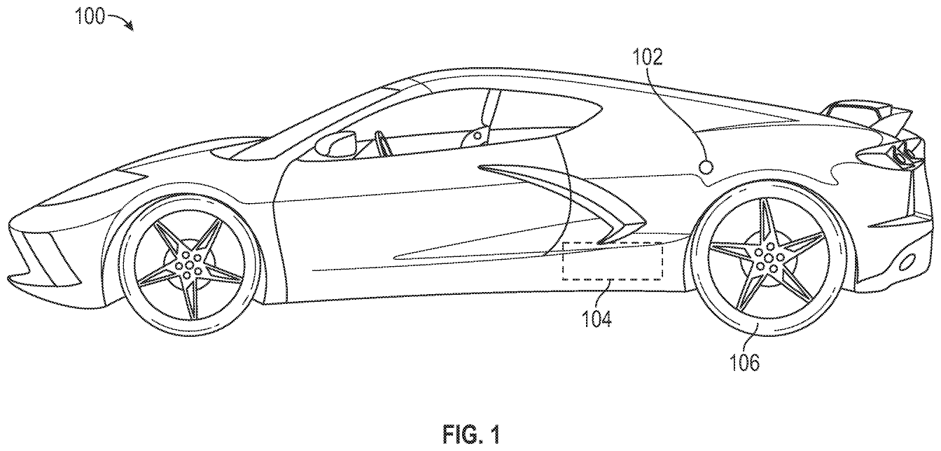

FIG. 1 provides a diagram of a vehicle 100 for use in conjunction with one or more embodiments of the present disclosure. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a high-voltage power source (i.e., a voltage source of at least 200 volts (V)), which is used to charge the battery 104. The electric motor 106 is configured to receive power from the battery 104 to provide propulsion for the vehicle 100.

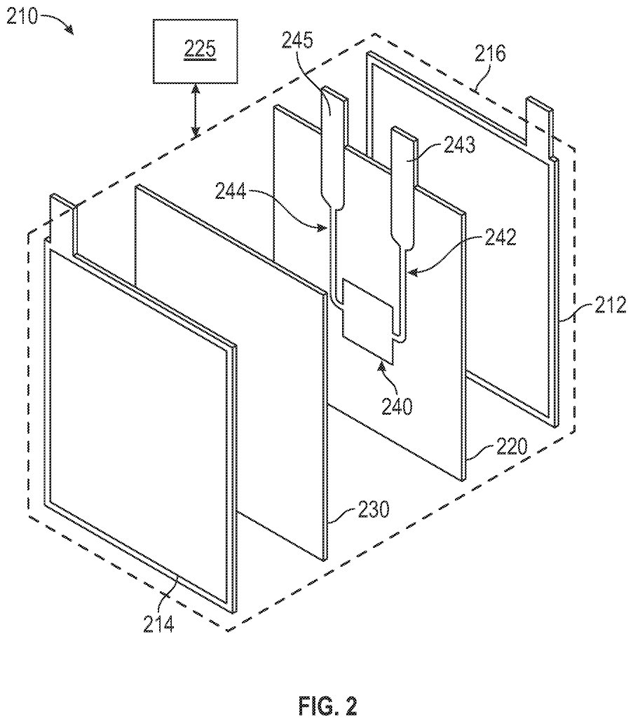

FIG. 2 is a diagram illustrating a battery cell with a thin-film functional separator in accordance with embodiments of the present disclosure. In this example, battery cell 210 may be an element of a battery pack or a battery system, such as battery 104 shown in FIG. 1, which may include a plurality of the battery cells 210.

In some embodiments, battery cell 210 is configured as a lithium-ion electrochemical cell that is arranged to provide a particular voltage in order to power, for example, electric motor 106 in FIG. 1. Battery cell 210 may include electrochemical materials in the form of a lithium ion solution containing electrolytes and/or electrode active materials that are responsible for electrical activity therein. The battery cell 210 includes an anode 212, a cathode 214, a thin-film separator 220, a sensor shield 230, and an electronic component 240 enclosed within an enclosure 216 that contains the electrochemical materials. As noted above, these electrochemical materials may be corrosive to conventional fasteners and couplers, and in turn such fasteners and couplers may be unsuitable to couple the thin-film separator 220 to an external conductive tab to supply power to the electronic component 240.

In the example depicted in FIG. 2, battery cell 210 is configured as a large format pouch cell, though embodiments of the present disclosure may operate in conjunction with any battery cells of any other suitable size, shape, and configuration. In this example, the electronic component 240 comprises a temperature sensor and a reference electrode, but embodiments of the present disclosure may operate in conjunction with thin-film separators that include any other suitable type of sensor or other functional component.

The separator 220 in battery cell 210 is disposed between, and physically separates, the anode 212 and the cathode 214. The sensor shield 230 is disposed between the electronic component 240 (comprising a temperature sensor in this example) and an adjacent one of the anode 212 or the cathode 214. In alternate embodiments, a battery cell operating in conjunction with embodiments of the present disclosure may have more or fewer components than that shown in the exemplary battery cell 210 shown in FIG. 2. For example, some alternate types of electronic components 240 may not require the sensor shield 230 layer.

The separator 220 comprises a porous, permeable, or semi-permeable composite membrane that includes a microporous substrate and a coating layer. The coating layer may be formed from a mixture of inorganic and/or organic particles and an aqueous or water-based polymeric binder. The coating layer may also be formed from filler material enabling or causing anisotropic electrical and/or thermal conduction. For example, the coating layer may include nanomaterials such as metallic, semi-metallic, or carbon-based nanoparticles, nanotubes, nanofibers, sheets or layers of graphene, or the like. Further, certain fillers may be used to provide enhanced structural characteristics. In addition to or in place of conductive fillers, structural fillers may be used, such as fibers, beads, granules, or the like, of a ceramic material, such a silicate or borosilicate glass, or another suitable material. The coating layer may also include porous material such as polyolefin (e.g., polyethylene, polypropylene), a polyarene (e.g., polystyrene, polyphenylene sulfide), or the like which permit lithium ions to pass through the coating layer.

The electronic component 240 is affixed to the thin-film separator 220, and includes a first electrode 242 and a second electrode 244 coupled, respectively, to a first lead 243 and a second lead 245. The electrodes 242, 244 may be fabricated from any suitable materials or combination of materials, such as gold, nickel, a conductive carbon black material, or another low reactivity platinum-group metal that is inactive in a lithium-ion chemistry. The first electrode 242 and the second electrode 244 may be fabricated for any conductive material that can be rendered porous when affixed onto the separator 220 by sputtering or another deposition process, and that remains inactive within the electrochemical materials of the battery cell 210.

The first and second leads 243, 245, respectively, electrically connect to the first and second electrodes 242, 244, respectively, and provide electrical connections to a monitoring controller 225. The electronic component 240 may be affixed to the separator 220 as a film layer by sputter-coating, or employing another form of physical vapor deposition. The affixation of the electronic component 240 as a film layer renders it porous and permeable to ion flow, thus avoiding disrupting lithium migration that includes the passing of liquid phase ion currents through the separator 220. In the example depicted in FIG. 2, the electronic component 240 is conductive and may be used to measure temperature within the battery cell 210. The measured temperature within the battery cell 210 may be extrapolated or otherwise employed to estimate temperature of a battery pack or a battery system in which the battery cell 210 is located by, for example, monitoring controller 225. In some embodiments, monitoring controller 225 may include a processor and memory storing instructions that, when executed by the processor, cause the monitoring controller to determine the temperature of the battery cell 210 or to perform other functionality suitable to the configuration of electronic component 240.

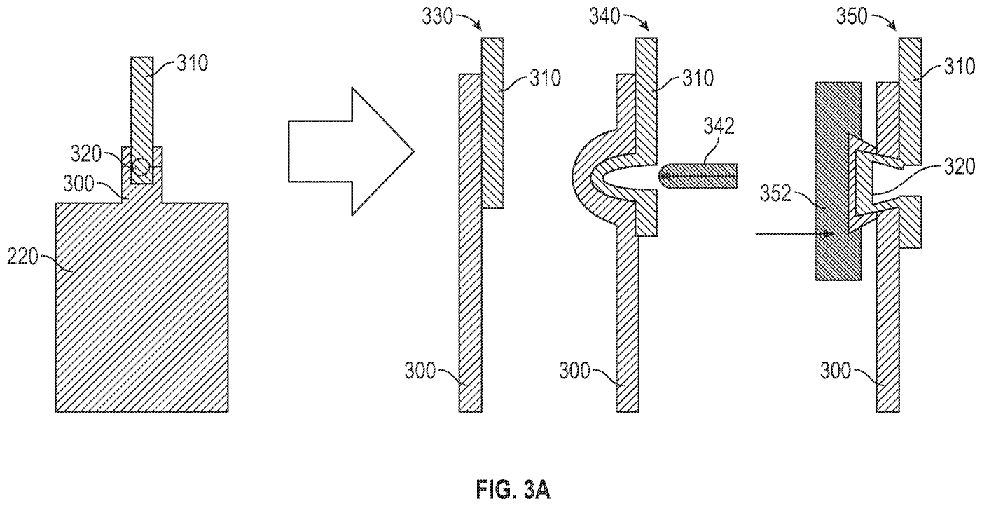

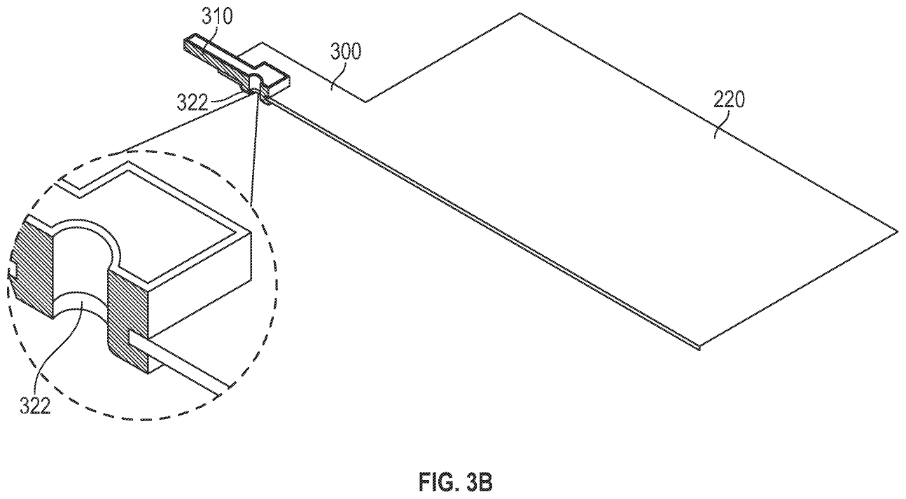

FIG. 3A is a diagram illustrating an embodiment of a mechanical connector for a thin-film functional separator in accordance with embodiments of the present disclosure. In this example, functional separator 220 has a lead 300 extending from the functional separator and comprising the same porous, permeable, or semi-permeable composite membrane (that includes a microporous substrate and a coating layer) as described above for the functional separator 220. In some embodiments, the lead 300 may be used to provide an electric coupling to an electric component coupled to the functional separator, such as electric component 240 shown in FIG. 2. For example, in some embodiments lead 300 may comprise first lead 243 or second lead 245 in FIG. 2.

The lead 300 is coupled to an external conductive tab 310 via a mechanical connector 320 that electrically couples the external conductive tab 310 to the lead 300 of the functional separator 220. The external conductive tab 310 may be formed from any suitable conductive material, such as gold, nickel, aluminum, or other conductive materials and combinations of such materials.

FIG. 3A illustrates an example of forming one such connector in accordance with various embodiments. At stage 330, the lead 300 of the functional separator 220 and external conductive tab 310 are placed in contact with one another. At stage 340, a punch action is applied at 342 to deform the lead 300 of the functional separator 220 and external conductive tab 310 as shown. At stage 350, a crimping action is applied at 352 to flatten and crimp the lead 300 of the functional separator 220 and external conductive tab 310 to form mechanical connector 320.

The connector 320 has a number of advantages. For example, it connects tab 310 with lead 300 without requiring any separate couplers or fasteners, thereby reducing the overall cost to manufacture battery cells employing the functional separator 220. Additionally, connector 320's utilization of the existing tab 310 and lead 300, formed from materials adapted to operate in the corrosive environment of the battery cell 210, ensure that the connector will not corrode and fail as a result of exposure to the electrochemical material of the battery cell 210.

FIG. 3B is another diagram illustrating a through-hole variant of the mechanical connector in FIG. 3A in accordance with embodiments of the present disclosure. In this example, the lead 300 of the functional separator 220 and external conductive tab 310 are placed in contact with one another as shown at stage 330 in FIG. 3A. However, instead of deforming the functional separator 220 and external conductive tab 310 as shown in stage 340 of FIG. 3A, the functional separator 220 and external conductive tab 310 are mechanically pierced to form a connector 322 having a through-hole that wraps the material of external conductive tab 310 around the lead 300 of the functional separator 220. The diagram in FIG. 3B is shown in perspective with a cutaway through the middle of the through-hole to show the material of conductive tab 310 enveloping both sides of the lead 300.

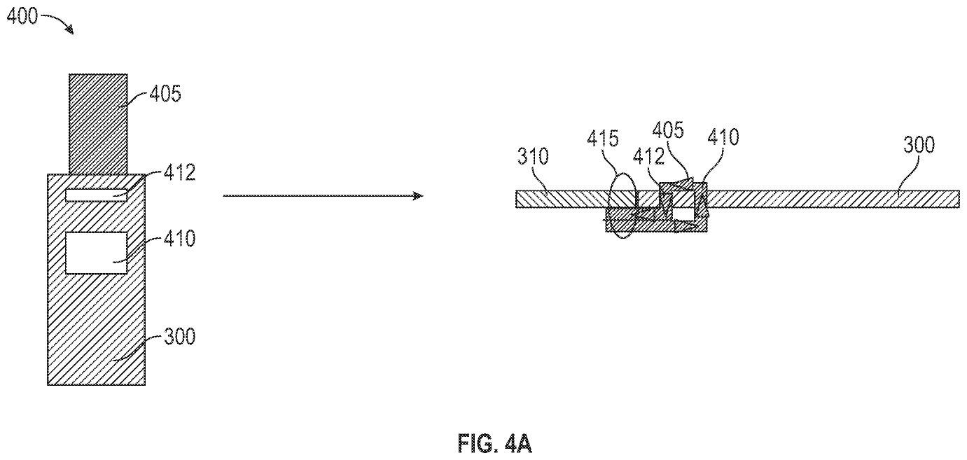

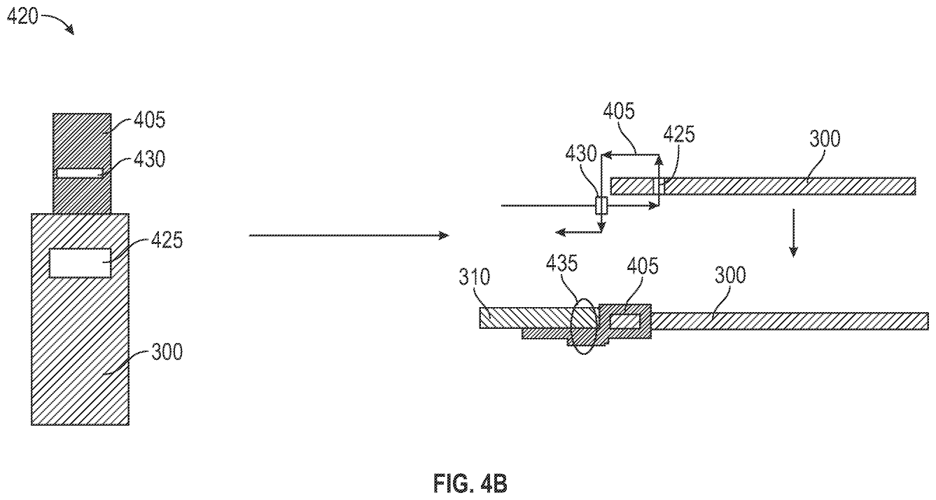

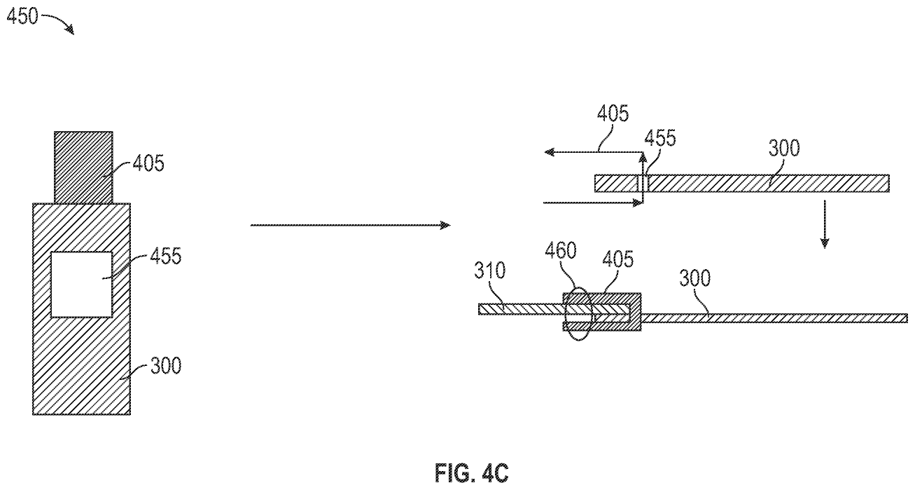

FIG. 4A is a diagram illustrating another embodiment of a mechanical connector for a thin-film functional separator in accordance with embodiments of the present disclosure. In this example, mechanical connection configuration 400 includes the lead 300 of the functional separator 220 with a first slit 410 and second slit 412 formed therein. A strip of conductive material 405 is wrapped through the first slit 410 in the lead 300 and through a second slit in the lead 412 as illustrated by the directional arrows shown in conjunction with the strip of conductive material 405. The conductive material is folded underneath itself and welded to the external conductive tab 310 at location 415. As illustrated in FIGS. 4A-4C the conductive strip 405 is shown as a component separate from conductive tab 310, though in alternate embodiments the conductive tab 310 may include the conductive strip 405 (e.g., the conductive tab 310 includes one contiguous structure that includes tab 310 and strip 405).

FIG. 4B is a diagram illustrating another embodiment of a mechanical connector for a thin-film functional separator in accordance with embodiments of the present disclosure. In this example, mechanical connection configuration 420 includes the lead 300 of the functional separator 220 with a slit 425 formed therein, and the strip of conductive material 405 having slit 430 therein. As illustrated by the directional arrows, the conductive material 405 is wrapped through the slit 425 in the lead 300 and through the slit 430 in the strip of conductive material 405. The strip of conductive material 405 is folded underneath itself in a manner similar to configuration 400 in FIG. 4A and welded to the external conductive tab 310 at location 435.

FIG. 4C is a diagram illustrating another embodiment of a mechanical connector for a thin-film functional separator in accordance with embodiments of the present disclosure. In this example, mechanical connection configuration 450 includes a slit 455 in lead 300 of the functional separator 220. The strip of conductive material 405 that is wrapped through the slit 455 as shown by the directional arrows and folded around the external conductive tab 310. The strip of conductive material is then welded to the external conductive tab 310 at location 460.

In the mechanical connector configurations illustrated in FIG. 4A, FIG. 4B, and FIG. 4C, the conductive strip 405 may be of any suitable size, shape, and configuration to traverse the described slits and to be welded to the external conductive tab 310. In some embodiments, the conductive strip 405 is formed from the same material as the conductive tab 310 (e.g., gold, nickel, aluminum, or other conductive materials and combinations of such materials). In some embodiments, the conductive strip 405 has a length of between about 1 mm and 8 mm, a length of between about 0.5 cm and 4 cm, and a thickness of between about 1 and 100 μm. The various slits described herein may likewise be of any suitable size, shape and configuration. For example, the slits may have a width of between about 0.9 mm and 7.9 mm and a length of between about 0.1 mm and 1 mm.

The connector configurations illustrated in FIG. 4A, FIG. 4B, and FIG. 4C provide a number of advantages in coupling the lead 300 of the thin-film functional separator 220 to the external conductive tab 310. For example, in each configuration, the conductive strip 405 is fed through the described slits to mechanically hold the lead 300 and tab 310 together. The conductive strip 405 can then be welded (at positions 415, 435, and 460 as shown) away from the material of the thin-film functional separator, which would melt or otherwise be destroyed by exposure to the high heat of the weld. These embodiments thus provide connectors between the lead 300 of the thin-film functional separator 220 and the external conductive tab 310 that allow a strong, durable weld to be applied without damaging the functional separator 220.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A thin-film functional separator for a battery cell, comprising:
a porous composite membrane that includes a microporous substrate and a coating layer, and includes a lead extending from the porous composite membrane;
an external conductive tab; and
a mechanical connector that electrically couples the external conductive tab to the lead extending from the porous composite membrane.

2. The thin-film functional separator of claim 1, wherein the thin-film functional separator is disposed within the battery cell.

3. The thin-film functional separator of claim 1, wherein the mechanical connector includes crimping the external conductive tab together with the lead extending from the porous composite membrane.

4. The thin-film functional separator of claim 1, wherein the mechanical connector includes a strip of conductive material that is wrapped through a first slit in the lead extending from the porous composite membrane, and through a second slit in the lead extending from the porous composite membrane, and wherein the strip of conductive material is welded to the external conductive tab.

5. The thin-film functional separator of claim 4, wherein the strip of conductive material is formed from a material in common with the external conductive tab.

6. The thin-film functional separator of claim 1, wherein the mechanical connector includes a strip of conductive material that is wrapped through a slit in the lead extending from the porous composite membrane and through a slit in the strip of conductive material, and wherein the strip of conductive material is welded to the external conductive tab.

7. The thin-film functional separator of claim 6, wherein the strip of conductive material is formed from a material in common with the external conductive tab.

8. The thin-film functional separator of claim 1, wherein the mechanical connector includes a strip of conductive material that is wrapped through a slit in the lead extending from the porous composite membrane and folded around, and welded to, the external conductive tab.

9. A battery cell, comprising:
an anode;
a cathode; and
a thin-film functional separator disposed between the anode and the cathode, the thin-film functional separator comprising:
a porous composite membrane that includes a microporous substrate and a coating layer, and includes a lead extending from the porous composite membrane;
an external conductive tab; and
a mechanical connector that electrically couples the external conductive tab to the lead extending from the porous composite membrane.

10. The battery cell of claim 9, wherein the mechanical connector includes crimping the external conductive tab together with the lead extending from the porous composite membrane.

11. The battery cell of claim 9, wherein the mechanical connector includes a strip of conductive material that is wrapped through a first slit in the lead extending from the porous composite membrane, and through a second slit in the lead extending from the porous composite membrane, and wherein the strip of conductive material is welded to the external conductive tab.

12. The battery cell of claim 11, wherein the strip of conductive material is formed from a material in common with the external conductive tab.

13. The battery cell of claim 9, wherein the mechanical connector includes a strip of conductive material that is wrapped through a slit in the lead extending from the porous composite membrane and through a slit in the strip of conductive material, and wherein the strip of conductive material is welded to the external conductive tab.

14. The battery cell of claim 13, wherein the strip of conductive material is formed from a material in common with the external conductive tab.

15. The battery cell of claim 9, wherein the mechanical connector includes a strip of conductive material that is wrapped through a slit in the lead extending from the porous composite membrane and folded around, and welded to, the external conductive tab.

16. A vehicle comprising:
an electric motor; and
a battery cell coupled to the electric motor, the battery cell comprising:
an anode;
a cathode; and
a thin-film functional separator disposed between the anode and the cathode, the thin-film functional separator comprising:
a porous composite membrane that includes a microporous substrate and a coating layer, and includes a lead extending from the porous composite membrane;
an external conductive tab; and
a mechanical connector that electrically couples the external conductive tab to the lead extending from the porous composite membrane.

17. The vehicle of claim 16, wherein the mechanical connector includes crimping the external conductive tab together with the lead extending from the porous composite membrane.

18. The vehicle of claim 16, wherein the mechanical connector includes a strip of conductive material that is wrapped through a first slit in the lead extending from the porous composite membrane, and through a second slit in the lead extending from the porous composite membrane, wherein the strip of conductive material is welded to the external conductive tab, and wherein the strip of conductive material is formed from a material in common with the external conductive tab.

19. The vehicle of claim 16, wherein the mechanical connector includes a strip of conductive material that is wrapped through a slit in the lead extending from the porous composite membrane and through a slit in the strip of conductive material, wherein the strip of conductive material is welded to the external conductive tab, and wherein the strip of conductive material is formed from a material in common with the external conductive tab.

20. The vehicle of claim 16, wherein the mechanical connector includes a strip of conductive material that is wrapped through a slit in the lead extending from the porous composite membrane and folded around, and welded to, the external conductive tab.
